(19) United States
(12) Patent Application Publication
(10) Pub. No.: US 2016/0368624 A1
(43) Pub. Date: Dec. 22, 2016

(54) GEOSAT PROPULSION SYSTEM ARCHITECTURE WITH ELECTRIC APOGEE MOTOR

(71) Applicant: Busek Co., Inc., Natick, MA (US)

(72) Inventors: Vladimir J. Hruby, Waban, MA (US); Bruce Pote, Sturbridge, MA (US)

(73) Assignee: Busek Co., Inc.

(21) Appl. No.: 15/138,748

(22) Filed: Apr. 26, 2016

Related U.S. Application Data
(60) Provisional application No. 62/180,372, filed on Jun. 16, 2015.

(51) Int. Cl. B64G 1/44; B64G 1/00; B64G 1/40

(52) U.S. Cl. CPC B64G 1/443; B64G 1/402; B64G 1/007

(57) ABSTRACT

A satellite system and method features one or more electric propulsion thrusters optimized to have a specific impulse for station keeping and connected to a propellant tank for ionizing a propellant during station keeping maneuvers and receiving power from a solar photovoltaic array via a power management and distribution system during station keeping maneuvers; one or more electric propulsion thrusters are optimized to have a thrust for orbit raising and are connected to the propellant tank for ionizing the propellant during orbit raising maneuvers and receiving power directly from the solar photovoltaic array during orbit raising maneuvers or from the power management and distribution system

### RELATED APPLICATION

This application claims benefit of and priority to U.S. Provisional Application Ser. No. 62/180,372 filed Jun. 16, 2015, under 35 U.S.C. §§119, 120, 363, 365, and 37 C.F.R. §1.55 and §1.78, which is incorporated herein by this reference.

### BACKGROUND OF THE INVENTION

In conventional Geostationary satellite systems, the satellite is typically delivered to an elliptical orbit called GEO transfer orbit (GTO) and is then released from the launch vehicle. Typically, chemical propulsion systems such as the bi-propellant apogee engine is then used for orbit raising, i.e., propelling the satellite to a geosynchronous orbit (GEO). See U.S. e.g., Patent Application Publication No. 2014/0061386 incorporated herein by this reference. A similar chemical propulsion system is then used for station keeping, i.e., maintaining the geosynchronous orbit, orbit maintenance, repositioning, de-orbit maneuvers, and the like.

With the advent of electric propulsion that offered much higher specific impulse than chemical propulsion and thus a significant propellant mass savings in turn allowed multiple satellite deployments using a single launch vehicle. See e.g., U.S. Pat. No. 8,915,472; Published Application No. US 2014/0061386; and U.S. Pat. No. 8,973,873, all incorporated herein by this reference.

Thus, the chemical propulsion system was removed and four electric propulsion systems were used for both orbit raising and station keeping. The particular thrusters used in the Boeing 702 satellite were gridded electrostatic Xenon ion thrusters (or XIP thrusters) offered by L3 Communications Electron Technologies, Inc.

The Electric Propulsion (EP) system enabled weight savings was substantial and two satellites could be launched via one launch vehicle. But, now with electric orbit raising it took about many months to transfer a satellite from GTO to GEO. Most satellite owners and users are not willing to wait such a long time for a satellite to be fully deployed and to become operational.

Featured is a satellite comprising a propellant tank, a solar photovoltaic array, and one or more electric propulsion thrusters optimized to have a specific impulse for station keeping and connected to the propellant tank for ionizing the propellant during station keeping maneuvers and receiving power from the solar photovoltaic array via a power management and distribution system during station keeping maneuvers. One or more electric propulsion thrusters are optimized to have a thrust for orbit raising and connected to the propellant tank for ionizing the propellant during orbit raising maneuvers and receiving power directly from the solar photovoltaic array during orbit raising maneuvers or from the power management and distribution system.

In one design, the one or more electric propulsion thrusters optimized for orbit raising are Hall Effect thrusters. The satellite may include a separation ring and the Hall Effect thruster may be mounted inside the separation ring. The one or more electric propulsion thrusters optimized for station keeping may include a gridded ion thruster and/or a Hall Effect thruster. The orbit raising thruster discharge may be connected directly to the solar array, or via a power processor that provides power conditioning for the thruster with or without galvanic isolation of the thruster. The satellite may further including a gimbled arm including an electric propulsion thruster optimized for station keeping and an electric propulsion thruster optimized for orbit raising.

Also featured is a method comprising raising a satellite to a geosynchronous orbit by delivering a propellant to a Hall Effect thruster and powering the Hall Effect thruster using power delivered to the thruster directly from a solar photovoltaic array of the satellite. Maintaining the geosynchronous orbit includes delivering the propellant to one or more electric gridded ion thrusters, and powering said thrusters using power delivered to the electric gridded ion thrusters from the solar photovoltaic array via a PMAD system.

Also featured is a method comprising launching a satellite including a propellant tank and a solar photovoltaic array to a geo transfer orbit, operating one or more electric propulsion thrusters optimized to have a thrust for orbit raising to ionize the propellant during an orbit raising maneuver and receiving power directly from the solar photovoltaic array during the orbit raising maneuver from a power management and distribution system; and operating one or more electric propulsion thrusters optimized to have a specific impulse for station keeping and to ionize the propellant during any station keeping maneuvers and receiving power from the solar photovoltaic array via a power management and distribution system during the station keeping maneuver.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Features and advantages of the invention will occur to those skilled in the art from the following description of a preferred embodiment and the accompanying drawings, in which:

FIG. 1 is a schematic three dimensional view showing a new satellite with electric propulsion systems in accordance with aspects of an example of the invention;

FIG. 2 is a schematic of alternative arrangement of EP thrusters on the satellite in accordance with the aspects of this invention;

FIG. 3 is a schematic cross sectional view showing the primary components associated with one preferred electric apogee motor for the satellite of FIG. 1;

FIG. 4 is a block diagram showing the primary components associated with a electric propulsion system in accordance with aspects of the invention;

FIG. 5 is a block diagram showing the power system and the electrical connections between the solar panels of the satellite of FIG. 1 and the various electrical propulsion systems; and

FIG. 6 is a more detailed block diagram showing how the electric apogee motor is directly connected to the solar array while the XIP station keeping thrusters are connected to the solar array via a PMAD.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

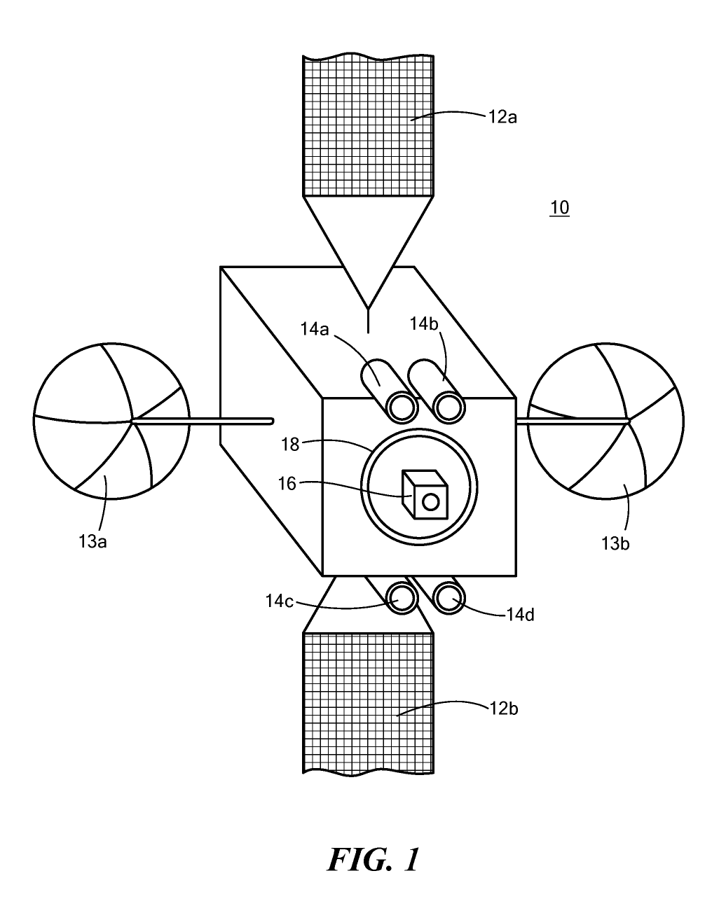

FIG. 1 shows satellite 10 (e.g., a Boeing 702SP satellite) with solar panels 12a and 12b and antennas. Satellite 10 has four electric propulsion units 14a, 14b, 14c, and 14d in the form of gridded electrostatic ion thrusters (XIP thrusters, L3 Communications Electronics Technologies, Inc.). The XIP thrusters are normally used for both station keeping and for orbit raising. However because of the high specific impulse of these XIP thrusters, the thrust they produce for a given power on the satellite is low and leads to long orbit raising time. This can be corrected by using one or more Hall thruster(s) 16 which is optimized for orbit raising. The units 14 may still be used for station keeping. Smaller Hall thrusters (e.g., 1-2 KW) may also replace XIP thrusters 14. Thruster 16 is located within separation ring 18.

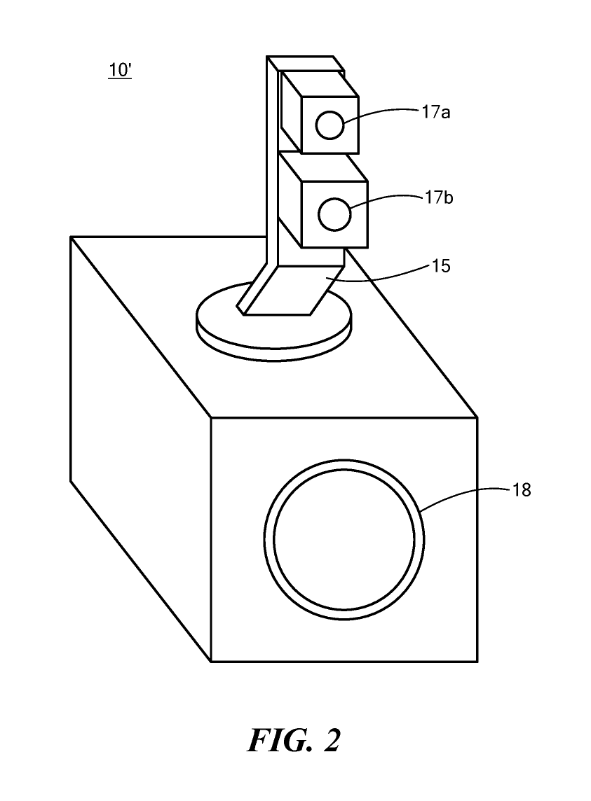

FIG. 2 shows an alternative arrangement of the EP thrusters on board of a GEO spacecraft 10′. Two gimbaled arms 15 are located on North and South sides of the spacecraft. Each arm/gimbal carries two electric thrusters 17a, 17b which could be Hall thrusters as shown or gridded ion thrusters or a combination of the two. The gimbaled arm with hall thrusters is used for example on the 1300 Series spacecraft made by SSL. The EP thrusters on each gimbal could be of the same size or one large and one small. The small thrusters 17a could be predominantly used for station keeping and the large thrusters 17b predominantly for orbit raising. However each would provide redundancy for the other and fulfill either function. Another attractive combination may be one large electric apogee motor located within separation ring 18 with four small hall thrusters on the armed gimbals. The small hall thrusters on small light weight gimbals could be used on all spacecraft sizes and only the large electric apogee motor would change according to the spacecraft power capability.

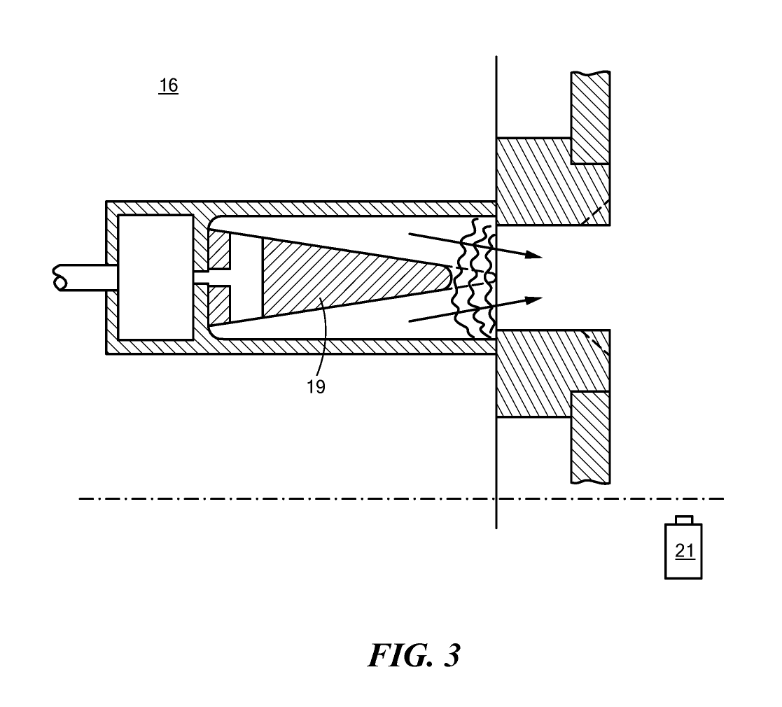

Thruster 16, FIG. 3 is a Hall Effect thruster used for orbit raising. Although only one thruster 16 is shown, two or more Hall thrusters can be used. Thruster 16 may be a model BHT-8000 (8 KW) thruster, (Busek Co., Inc. Natick, Mass.). See e.g., U.S. Pat. No. 6,075,321 incorporated herein by this reference. As shown in FIG. 1 thruster 16 may be mounted centrally inside separation ring 18 where previously a chemical apogee motor was used. The Hall Effect thruster(s) 16 can be fixed mounted to the spacecraft avoiding a gimbal with the gimbled thrusters 14 performing spacecraft steering. Thruster 16, FIG. 3 includes anode 19, and cathode 21.

The result now includes satellites which are lighter weight than satellites with a chemical apogee motor, satellites which can be stacked for launch in a single launch vehicle, and satellites which are transferred to geosynchronous orbit much faster than current Boeing 702SP satellite with only XIP thrusters for both station raising and station keeping. Thruster 16 may be configured per the specifications of Table 1 below which shows the performance of the Busek BHT-8000 thruster designed for nominal input of 8000 W. Smaller or larger thrusters can be used in its place.

TABLE 1

| Thruster | | | | Thruster | Nominal |
|---|---|---|---|---|---|
| Input | Discharge | | | Total | % of Full |
| Power | Voltage | Thrust | Isp | Eff. | Thruster |
| (W) | (V) | (mN) | (s) | % | Power |
| 8,061 | 400 | 449 | 2217 | 60.6 | 100 |
| 8,058 | 600 | 377 | 2637 | 60.5 | 100 |
| 8,047 | 800 | 325 | 3068 | 60.7 | 100 |
| 6,295 | 400 | 359 | 2165 | 60.6 | 75 |
| 6,327 | 600 | 295 | 2583 | 59.1 | 75 |
| 6,342 | 800 | 238 | 3152 | 58 | 75 |
| 4,537 | 400 | 260 | 2077 | 58.4 | 50 |
| 4,544 | 600 | 198 | 2696 | 57.6 | 50 |
| 4,563 | 800 | 172 | 3203 | 59.2 | 50 |

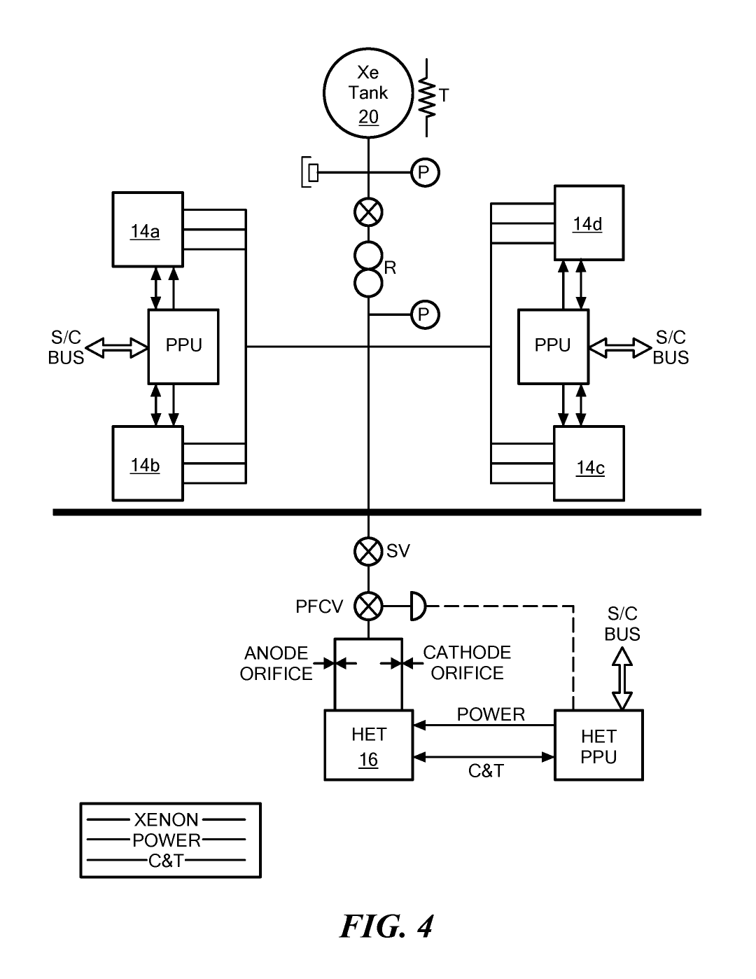

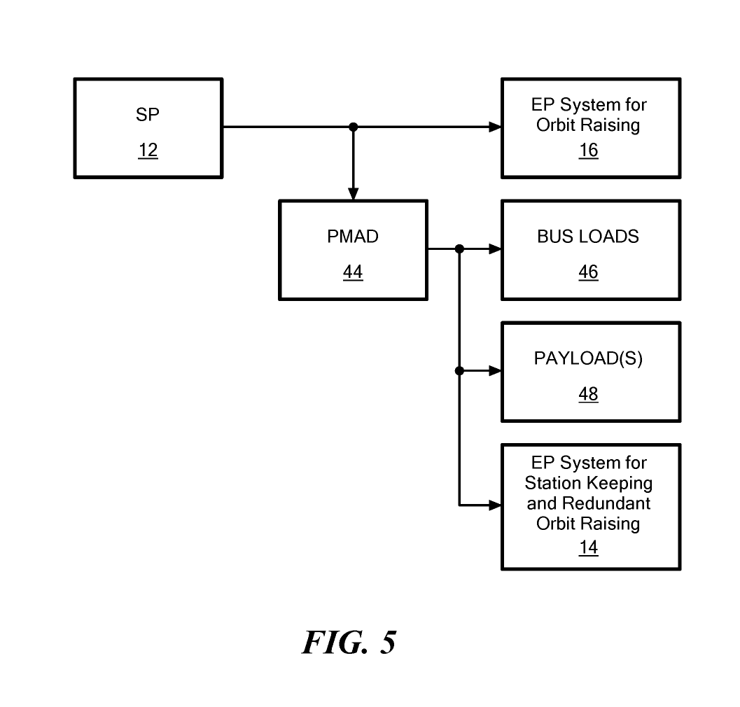

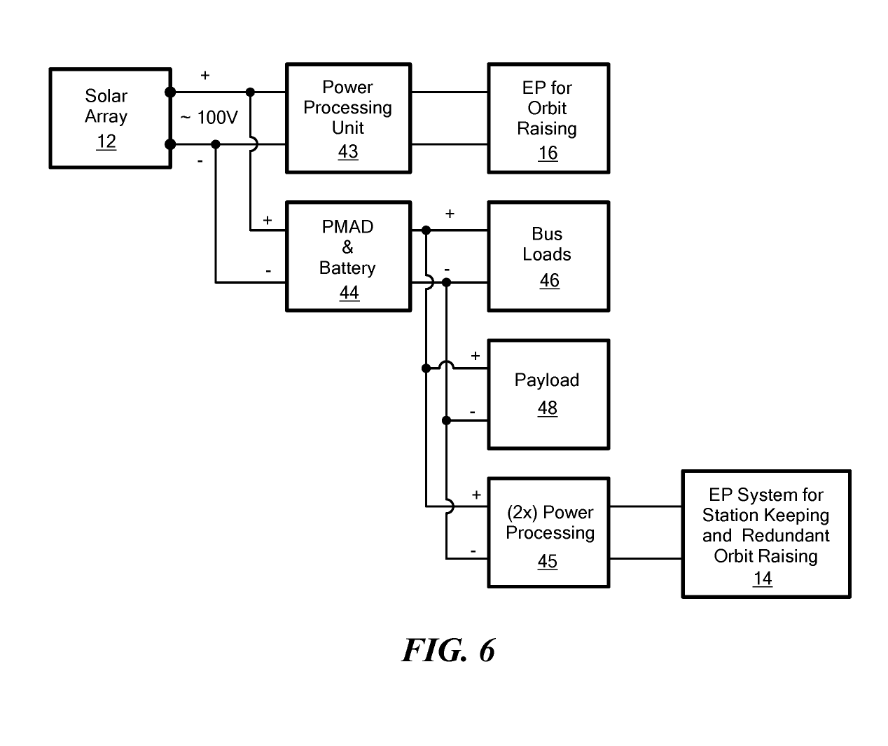

As shown in FIG. 4, the electric apogee orbit raising motor 16 may share the same Xenon tank 20 as the station keeping thrusters 14a-14d. Furthermore, the Hall Effect thruster 16, FIGS. 5-6 may be directly connected to the solar panels 12 as disclosed in U.S. Pat. No. 8,550,405 incorporated herein by this reference and the thrusters 14 may be powered by the PMAD 44. The Hall Effect thruster may also be powered via the PMAD 44. Thrusters 14 may be XIP thrusters or small Hall Effect thrusters (e.g., 1-2 KW). Thruster 16 may be an 8-12 KW Hall thruster.

In accordance with one embodiment of this invention, FIG. 5, PMAD unit 44 is removed from the power path to EP system 16 and the solar array SP 12 is connected directly to EP system 16. Connections are made to the anode, cathode, and electromagnetics of the orbit raising Hall thruster 16. PMAD unit 44 is now much smaller. It handles much less power and therefore can be smaller resulting in mass and volume savings and because it processes less power it also has lower losses. The heat generated by these power losses in the PMAD would be rejected from the spacecraft to maintain its temperature within operating limits. Heat rejection equipment (radiators) are heavy with a specific mass of the order of 30 kg per KW of rejected heat. This lower loss or equivalently higher efficiency power processing not only results in a smaller array but also in smaller radiators, in both cases significantly reducing the spacecraft mass. EP system 16 includes a thruster power supply and a Hall Effect thruster. In a Hall Effect thruster the thruster power supply is a discharge power supply (DPS).

Power is generated by a solar photovoltaic array (SP) 12 and flows into the power management and distribution (PMAD) system 44. From there it is distributed to all the bus loads 46 and payload(s) 48 and station keeping EP subsystem 14.

FIG. 6 shows a block diagram of the power system applicable for the electric apogee motor implementation shown in FIG. 1. Solar array 12 delivers power to a Power Processor 43 in parallel with conventional PMAD 44. The PMAD conditions power for the bus loads 46, the payload 48 and feeds power to power processors 45 than in turn condition power for the gimbaled EP thrusters. Typical GEOsat has 4 of these thrusters (14) fed by 2 power processors, allowing only 2 of the 4 thrusters to operate at a time with the two remaining thrusters providing redundancy. Depending on the spacecraft mobility and reliability requirements there may be more than two power processors 45. The large power processor unit 43 will have at least three variants depending on the propulsion system architecture. (1) classical power processor with galvanic isolation between the array 12 and the hall thruster 16; (2) power processing without isolation which is substantially simpler than with isolation; and (3) direct connection of the solar array 12 to the discharge of the hall thruster in which case the content of the power processor unit 43 is minimal, conditioning power only for the cathode and electromagnets.

Assuming that the gridded ion thrusters and large hall thrusters have nearly the same efficiency and that they receive the same power, their thrust is inversely proportional to their specific impulse (ISP) and directly propulsion to the transit time from GTO to GEO. The typical gridded ion thruster specific impulse is 3500 s (XIPs 25 by L3 at 4.5 kW) and large hall thruster will remain efficient down to 1400 s. The ratio is 2.5, which means that a hall thruster will deliver a spacecraft to its destination 2.5 times faster than ion thruster cutting the transit time from the typical 6 months to 2.4 months. Thus the satellite owner/user could operate the satellite 3.6 months earlier which represents millions of dollars of additional revenue. This top level estimates indicate that the ideal propulsion system would consist of high ISP for station keeping (Isp>1800 sec) and high thrust (e.g. thrust to input power ratio of 65 mN/kW or higher) for orbit raising. The latter means a hall thruster with ISP throttled down to maximize thrust until there is a loss of thruster efficiency or until there is too much propellant for dual satellite manifestation on the launch vehicle.

Featured is an all electric propulsion architecture that uses a dedicated Hall Effect thruster for orbit raising and separate electric thrusters for station keeping. This allows optimization of each electric propulsion thruster according to its function as opposed to a one size fits all architecture.

Thus, the orbit raising thruster is separated from the thrusters that perform station keeping. This allows each thruster to be optimized for its intended use/function. Preferably, the electric orbit raising thruster requires a larger thruster capable of consuming all power on the satellite to deliver the satellite to the destination as fast as possible subject to power and specific impulse constraints while the station keeping thrusters can use much smaller, lower cost thrusters operating at high specific impulse to conserve propellant. The power supply for the orbit raising Hall Effect thruster can be connected directly to the solar array bypassing the traditional satellite power management and distribution (PMAD) system and battery banks. This allows nearly all of the available power generated by the array at the beginning of the mission to be used for orbit raising unconstrained by the size of the PMAD and battery bank. This feature minimizes the orbit raising time allowing the satellite to reach its destination orbit faster and generate revenue earlier than would have been possible under conventional architectures.

The result of an optimized selection of thrusters according to their function includes a system where the orbit raising is performed by one (or more) larger hall thrusters placed on the satellite where the tradition chemical apogee motor was located and a set of small thrusters to perform station keeping. As an example of a system for the Boeing 702SP satellite, the Busek HET-8000 is used for orbit raising and two or more gridded ion thrusters (XIPs) are used for station keeping. The XIPs can also be replaced by small HETs such as the BHT-1500 to achieve a lower cost system. The advanced Hall thrusters can operate at specific impulse (ISP) as high as 3,000 s approaching the XIP Isp-3,500 s thus achieving similar propellant consumption as XIPs.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A satellite comprising:
a propellant tank;
a solar photovoltaic array;
one or more electric propulsion thrusters optimized to have a specific impulse for station keeping and connected to the propellant tank for ionizing the propellant during station keeping maneuvers and receiving power from the solar photovoltaic array via a power management and distribution system during station keeping maneuvers; and
one or more electric propulsion thrusters optimized to have a thrust for orbit raising and connected to the propellant tank for ionizing the propellant during orbit raising maneuvers and receiving power directly from the solar photovoltaic array during orbit raising maneuvers or from the power management and distribution system.

2. The satellite of claim 1 in which the one or more electric propulsion thrusters optimized for orbit raising are Hall Effect thrusters.

3. The satellite of claim 2 further including a separation ring and in which the Hall Effect thruster is mounted inside the separation ring.

4. The satellite of claim 1 in which the one or more electric propulsion thrusters optimized for station keeping includes a gridded ion thruster and/or a Hall Effect thruster.

5. The satellite of claim 1 where the orbit raising thruster discharge is connected directly to the solar array, or via a power processor that provides power conditioning for the thruster with or without galvanic isolation of the thruster.

6. The satellite of claim 1 further including a gimbled arm including an electric propulsion thruster optimized for station keeping and an electric propulsion thruster optimized for orbit raising.

7. A method comprising:
raising a satellite to a geosynchronous orbit by:
delivering a propellant to a Hall Effect thruster and powering the Hall Effect thruster using power delivered to the thruster directly from a solar photovoltaic array of the satellite; and
maintaining said geosynchronous orbit by:
delivering the propellant to one or more electric gridded ion thrusters, and
powering said thrusters using power delivered to the electric gridded ion thrusters from the solar photovoltaic array via a PMAD system.

8. A method comprising:
launching a satellite including a propellant tank and a solar photovoltaic array to a geo transfer orbit;
operating one or more electric propulsion thrusters optimized to have a thrust for orbit raising to ionize the propellant during an orbit raising maneuver and receiving power directly from the solar photovoltaic array during the orbit raising maneuver from a power management and distribution system; and
operating one or more electric propulsion thrusters optimized to have a specific impulse for station keeping and to ionize the propellant during any station keeping maneuvers and receiving power from the solar photovoltaic array via a power management and distribution system during the station keeping maneuver.

9. The method of claim 8 in which the one or more electric propulsion thrusters optimized for orbit raising are Hall Effect thrusters.
